(19) United States
(12) Patent Application Publication
(10) Pub. No.: US 2023/0230305 A1
(43) Pub. Date: Jul. 20, 2023

(54) ONLINE STREAMER AVATAR GENERATION METHOD AND APPARATUS

(71) Applicant: SHANGHAI BILIBILI TECHNOLOGY CO., LTD., Shanghai (CN)

(72) Inventors: Yilai SHENG, Shanghai (CN); Huaizhou ZHANG, Shanghai (CN); Junhao HU, Shanghai (CN)

(21) Appl. No.: 18/152,433

(22) Filed: Jan. 10, 2023

(30) Foreign Application Priority Data
Jan. 17, 2022 (CN) 202210049881.0

(51) Int. Cl. G06T 13/40; G06V 40/20; G06V 40/16; G06T 7/246

(52) U.S. Cl. CPC G06T 13/40; G06V 40/23; G06V 40/171; G06V 40/176; G06T 7/246

(57) ABSTRACT

This application provides techniques of generating a virtual character for an online streamer. The techniques comprises obtaining a human body image of a target online streamer captured by an image collection device, wherein the human body image of the target online streamer comprises at least a face and an upper body part of the target online streamer; separately performing face recognition and upper-body limb recognition on the human body image to obtain face features and limb features; determining parameters associated with a virtual character corresponding to the target online streamer based on the face features and the limb features; and generating the virtual character corresponding to the target online streamer based on the parameters, wherein the generated virtual character has a motion and an expression corresponding to that of the target online streamer.

### CROSS-REFERENCE TO RELATED APPLICATION

The present application claims priority to Chinese Patent Application No. 202210049881.0, filed on Jan. 17, 2022, which is incorporated herein by reference in its entirety.

### BACKGROUND

With the development of Internet technologies, live streaming becomes more popular. As Internet enabled devices, such as mobile phones, become more sophisticated, people continue to discover new ways for live streaming.

### SUMMARY

In view of this, embodiments of this application provide an online streamer avatar generation method. This application also relates to an online streamer avatar generation apparatus, a computing device, and a computer-readable storage medium, to resolve a problem in a conventional technology that generation of an online streamer avatar is not convenient.

According to a first aspect of the embodiments of this application, an online streamer avatar generation method is provided, including:

obtaining a human body image that is collected by an image collection device and that is of a target online streamer, where the human body image includes at least the face and the upper body of the target online streamer;

separately performing face recognition and upper-body limb recognition on the human body image to obtain a face feature and a limb feature; and

setting an avatar parameter of the target online streamer based on the face feature and the limb feature, and generating an avatar corresponding to the target online streamer based on the avatar parameter.

According to a second aspect of the embodiments of this application, an online streamer avatar generation apparatus is provided, including:

an image obtaining module, configured to obtain a human body image that is collected by an image collection device and that is of a target online streamer, where the human body image includes at least the face and the upper body of the target online streamer;

a feature obtaining module, configured to separately perform face recognition and upper-body limb recognition on the human body image to obtain a face feature and a limb feature; and

an avatar generation module, configured to: set an avatar parameter of the target online streamer based on the face feature and the limb feature, and generate an avatar corresponding to the target online streamer based on the avatar parameter.

According to a third aspect of the embodiments of this application, a computing device is provided, including a memory, a processor, and computer instructions stored in the memory and capable of running on the processor, where when executing the computer instructions, the processor implements steps of the online streamer avatar generation method.

According to a fourth aspect of the embodiments of this application, a computer-readable storage medium is provided, where the computer-readable storage medium stores computer instructions, and when the computer instructions are executed by a processor, steps of the online streamer avatar generation method are implemented.

In an embodiment of this application, the human body image that is collected by the image collection device and that is of the target online streamer is obtained, where the human body image includes at least the face and the upper body of the target online streamer; face recognition and upper-body limb recognition are separately performed on the human body image, to obtain the face feature and the limb feature; and the avatar parameter of the target online streamer is set based on the face feature and the limb feature, and the avatar corresponding to the target online streamer is generated based on the avatar parameter. A limb motion of the upper body is generally characterized by a small change amplitude and a small change speed. In addition, the human body image includes at least the face of and the upper body of the target online streamer. Therefore, the human body image collected by the image collection device is directly obtained, so that face recognition and upper-body limb recognition can be separately performed on the human body image to obtain the face feature and the limb feature. In addition, the face feature and the limb feature represent features of the head and the upper body of the target online streamer, and may reflect a motion and an expression of the target online streamer. Therefore, in this embodiment, the motion and the expression of the target online streamer may be directly captured by using the image collection device, and a dedicated capture device does not need to be used. On this basis, the avatar parameter of the target online streamer is set based on the face feature and the limb feature, and the avatar corresponding to the target online streamer is generated based on the avatar parameter. This can ensure that the generated avatar corresponds to the motion and the expression of the target online streamer, to ensure content richness in livestreaming. Therefore, in this solution, an online streamer avatar can be generated without using the dedicated capture device, so that both convenience and content richness in livestreaming can be considered.

### BRIEF DESCRIPTION OF DRAWINGS

FIG. 1 is a flowchart of an online streamer avatar generation method according to an embodiment of this application;

FIG. 2 is a schematic diagram of a roll angle, a yaw angle, and a pitch angle of the head in an online streamer avatar generation method according to another embodiment of this application;

FIG. 3 is a schematic flowchart of updating a head pose parameter in an online streamer avatar generation method according to another embodiment of this application;

FIG. 4 is a schematic diagram of an expression feature point in an online streamer avatar generation method according to another embodiment of this application;

FIG. 5 is a schematic flowchart of updating a facial expression parameter in an online streamer avatar generation method according to another embodiment of this application;

FIG. 6 is a schematic flowchart of updating a limb pose parameter in an online streamer avatar generation method according to another embodiment of this application;

FIG. 7 is a schematic flowchart of an online streamer avatar generation method according to another embodiment of this application;

FIG. 8 is a schematic diagram of a structure of an online streamer avatar generation apparatus according to an embodiment of this application; and

FIG. 9 is a block diagram of a structure of a computing device according to an embodiment of this application.

### DESCRIPTION OF EMBODIMENTS

Many specific details are described in the following descriptions to facilitate full understanding of this application. However, this application can be implemented in many different manners from those described herein. A person skilled in the art may make similar promotion without departing from the connotation of this application. Therefore, this application is not limited to the specific implementations disclosed below.

Terms used in one or more embodiments of this application are merely used to describe specific embodiments, but are not intended to limit the one or more embodiments of this application. The terms “a” and “the” of singular forms used in one or more embodiments and the appended claims of this application are also intended to include plural forms, unless otherwise specified in the context clearly. It should be further understood that the term “and/or” used in one or more embodiments of this application indicates and includes any or all possible combinations of one or more associated listed items.

It should be understood that although terms such as “first” and “second” can be used in one or more embodiments of this application to describe various types of information, the information is not limited to these terms. These terms are merely used to differentiate between information of a same type. For example, without departing from the scope of one or more embodiments of this application, “first” may also be referred to as “second”, and similarly, “second” may also be referred to as “first”. Depending on the context, for example, the word “if” used herein may be explained as “while”, “when”, or “in response to determining”.

First, nouns related to one or more embodiments of this application are explained.

Motion capture means tracking a key part of an object, and processing a track result by using a computer to obtain data representing motion in a three-dimensional spatial coordinate system.

Facial capture means tracking a face outline and a feature point, and obtaining a location and key point coordinate data of the face after processing.

An RGB camera is also referred to as a color camera. RGB represents colors of red, green, and blue channels. The camera may be used to collect a very accurate color image.

Inverse kinematics (IK) is used to calculate a joint angle required when a spatial location of an end is given.

Machine learning (ML) is a multi-disciplinary subject that specializes in how a computer simulates or implements learning behavior of a human being, to obtain new knowledge or skills and reorganize an existing knowledge structure to constantly improve performance of the computer.

A region of interest (ROI) is a region that needs to be processed in a processed image in machine vision and image processing. In one case, the region of interest may be outlined by using a specified shape such as a square, a circle, an ellipse, or an irregular polygon, to facilitate use of the region of interest.

A regression algorithm is a machine learning algorithm used for continuous distribution prediction. The regression algorithm is used for a sample of a value type, and the regression algorithm can predict a value for a given input. In this way, continuous data instead of a discrete category label can be predicted.

A pose is location and rotation data.

Avatar drive means using pose and expression data to enable an avatar to present a motion or an expression the same as or similar to that of a real person captured by a camera.

A virtual character (i.e., avatar) that has a motion and an expression the same as or similar to that of a real online streamer may be displayed in a video frame based on a motion and an expression of the real online streamer. This can greatly improve content richness in livestreaming. The motion and the expression of the real online streamer are usually captured by using a professional capture device. However, the foregoing professional capture device is generally complex to operate, and a dedicated use site needs to be configured. Therefore, a more convenient solution needs to be provided.

This application provides improved techniques of generating a virtual character (i.e., avatar) for an online streamer. This application also relates to an online streamer avatar generation apparatus, a computing device, and a computer-readable storage medium. The online streamer avatar generation method, the online streamer avatar generation apparatus, the computing device, and the computer-readable storage medium are described in detail one by one in the following embodiments.

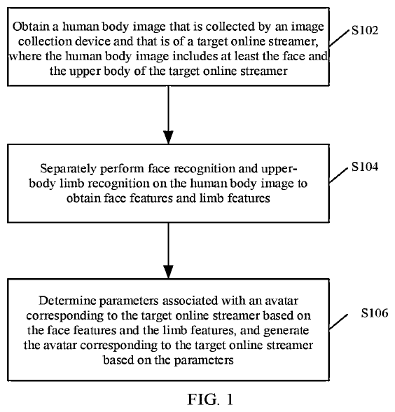

FIG. 1 is a flowchart of an online streamer avatar generation method according to an embodiment of this application. The method specifically includes the following steps.

S102. Obtain a human body image that is collected by an image collection device and that is of a target online streamer, where the human body image includes at least the face and the upper body of the target online streamer.

In specific application, the online streamer avatar generation method provided in this embodiment of this application may be applied to a live client or a live server. In addition, there may be specifically a plurality of image collection devices. For example, the image collection device may be a camera mounted on the live client, for example, a camera on a mobile terminal. Alternatively, for example, the image collection device may be an image collection device that is communicatively connected to the live client and that is independent of the client, for example, an RGB camera or a video camera that may be communicatively connected to the client. In addition, there may be specifically a plurality of manners of obtaining the human body image that is collected by the image collection device and that is of the target online streamer. For example, if this embodiment of this application is applied to a live client, the human body image that is collected by the image collection device and that is of the target online streamer may be directly received. Alternatively, if this embodiment of this application is applied to the live server, the human body image that is collected by the image collection device, that is of the target online streamer, and that is sent by a live client may be directly received. These are all reasonable. In addition, when data collected by the image collection device is a live video, a video frame that includes at least the face and the upper body of the target online streamer may be collected from the live video to obtain the human body image.

S104. Separately perform face recognition and upper-body limb recognition on the human body image to obtain face features and limb features.

In specific application, different from a dedicated capture device, the image collection device generally cannot implement long-distance capturing, and is prone to interference. In addition, the online streamer mostly sits to perform livestreaming. For this subdivided usage scenario, in this embodiment, the human body image includes at least the face and the upper body of the target online streamer, and face recognition and upper-body limb recognition are separately performed on the human body image to obtain the face feature and the limb feature. In this way, a characteristic that a limb motion of the upper body generally has a small change amplitude and a small change speed may be used, to ensure that the face feature and the limb feature that are obtained in this step may separately represent the face and a pose of the target online streamer. In addition, the pose of the upper body of the target online streamer refers to location and rotation data of the upper body of the target online streamer, and may reflect the limb motion of the upper body of the target online streamer. Therefore, in this step, facial capture and motion capture may be performed on an online streamer by using the image collection device.

In addition, there may be a plurality of manners of separately performing face recognition and upper-body limb recognition on the human body image to obtain the face feature and the limb feature. For example, a face template may be set based on shape data of a facial organ and a distance relationship between facial organs. A part that is in the human body image and that matches the face template is determined as the face feature. Similarly, an upper-body limb template may be set based on shape data of an upper-body limb and a distance relationship between upper-body limbs. A part that is in the human body image and that matches the upper-body limb template is determined as the limb feature. Alternatively, for example, a face region in which the face exists may be recognized from the human body image, and a face feature point in the face region is recognized to obtain the face feature. A limb region in which an upper-body limb exists is recognized from the human body image, and a limb feature point in the limb region is recognized to obtain the limb feature. For ease of understanding and proper layout, the second example is subsequently described in a form of an optional embodiment.

In addition, there may be specifically a plurality of face features and a plurality of limb features. For example, the face feature and the limb feature each may be a feature point, a region of interest, a texture, and grayscale. These are all reasonable.

S106. Determine avatar parameters of the target online streamer based on the face features and the limb features, and generate an avatar corresponding to the target online streamer based on the avatar parameter.

The avatar parameters comprise a first type of parameter indicating a head pose of the target online streamer (i.e., head pose parameter), a second type of parameter indicating a facial expression of the target online streamer (i.e., facial expression parameter), and a third type of parameter indicating a limb pose of the target online streamer (i.e., limb pose parameter). In specific application, there may be a plurality of manners of determining the avatar parameters of the target online streamer based on the face features and the limb features. For example, a pre-established correspondence between an avatar parameter and a face feature may be searched for an avatar parameter that matches the face feature, to use the avatar parameter as a head image parameter of the target online streamer. A pre-established correspondence between an avatar parameter and a limb feature is searched for an avatar parameter that matches the limb feature, to use the avatar parameter as a limb image parameter of the target online streamer. The head image parameter and the limb image parameter are determined as the avatar parameter of the target online streamer. Alternatively, for example, head pose, facial expression, and limb parsing may be separately performed on the face features, and the avatar parameters of the target online streamer are obtained based on a parsing result. For ease of understanding and proper layout, the second example is subsequently described in a form of an optional embodiment.

In addition, there may be specifically a plurality of manners of generating the avatar corresponding to the target online streamer. For example, a preset avatar may be obtained, and the preset avatar is updated by using the avatar parameters of the target online streamer, to obtain the avatar corresponding to the target online streamer. Alternatively, for example, a pre-established correspondence between an avatar and avatar parameters may be searched for an avatar corresponding to the avatar parameters of the target online streamer, to use the avatar as the avatar corresponding to the target online streamer. Any manner in which the avatar corresponding to the target online streamer may be generated based on the avatar parameters may be applied to this application. This is not limited in this embodiment.

In an embodiment of this application, a limb motion of the upper body is generally characterized by a small change amplitude and a small change speed. In addition, the human body image includes at least the face of and the upper body of the target online streamer. Therefore, the human body image collected by the image collection device is directly obtained, so that face recognition and upper-body limb recognition can be separately performed on the human body image to obtain the face features and the limb features. In addition, the face features and the limb features represent features of the head and the upper body of the target online streamer, and may reflect a motion and an expression of the target online streamer. Therefore, in this embodiment, the motion and the expression of the target online streamer may be directly captured by using the image collection device, and a dedicated capture device does not need to be used. On this basis, the avatar parameters of the target online streamer is determined based on the face features and the limb features, and the avatar corresponding to the target online streamer is generated based on the avatar parameters. This can ensure that the generated avatar corresponds to the motion and the expression of the target online streamer, to ensure content richness in livestreaming. Therefore, in this solution, an online streamer avatar can be generated without using the dedicated capture device, so that both convenience and content richness in livestreaming can be considered.

In an optional implementation, the separately performing face recognition and upper-body limb recognition on the human body image to obtain a face feature and a limb feature may specifically include the following steps:

recognizing a face region from the human body image, and determining the face feature based on the face region; and

recognizing an upper-body limb region from the human body image, and determining the limb feature based on the upper-body limb region.

In specific application, there may be specifically a plurality of face features. For example, the face feature may be a feature point, a region of interest, a texture, and grayscale of the face region. The feature point of the face region is a face feature point, and may be specifically a pixel in the face region or location information of the pixel in the face region. Similarly, there may be specifically a plurality of limb features. For example, the limb feature may be a feature point, a region of interest, a texture, and grayscale of the upper-body limb region. The feature point of the upper-body limb region is a limb feature point, and may be specifically a pixel in the limb region or location information of the pixel in the limb region. In addition, recognizing the face region from the human body image and recognizing the upper-body limb region from the human body image are similar, and both mean recognizing a region of interest. A difference lies in that content in the recognized regions of interest is different, content in the face region is the face, and content in the upper-body limb region is the upper-body limb. In this embodiment, a region of interest is first recognized, and then a feature such as a face feature and a limb feature is determined based on the region of interest, so that efficiency reduction and false recognition caused by directly performing feature recognition on the entire human body image can be reduced, to improve efficiency and accuracy.

In addition, an online streamer livestreaming scenario is generally fixed. Therefore, the region of interest may be recognized by comparing the human body image with a reference image. The reference image is an image that does not include a human body and that is the same as or similar to the online streamer livestreaming scenario. Specifically, a target region that is different from the reference image and whose area is greater than an area threshold may be recognized from the human body image as the region of interest. In one case, the target region may be a plurality of mutually independent regions. In addition, the face and the upper-body limb have a specified shape and area interval. Therefore, the target region may be outlined by using an edge point of the target region, and a target region whose outline matches a specified shape and whose area belongs to a specified interval is used as the region of interest. If the region of interest is a face region, the specified shape may be an ellipse, a circle, or the like, and the specified interval is a face area interval determined based on experience or a sample face. If the region of interest is an upper-body limb region, the specified shape may be a rectangle, a rectangle connected to the face region, and the like, and the specified interval is an upper-body area interval determined based on experience or a sample upper body. Alternatively, the steps in this embodiment may be implemented based on machine learning, and the following is specifically described in a form of an optional embodiment.

In an optional implementation, the recognizing a face region from the human body image, and determining the face feature based on the face region may specifically include the following steps: inputting the human body image into a pre-trained face recognition model to obtain the face region in the human body image; and

determining first location information of a face feature point in the face region, and determining the face feature based on the first location information.

In specific application, the face recognition model is trained by using a sample human body image, a region label of a sample face in the sample human body image, and a location label of a sample face feature point in the sample face. The first location information may be coordinates of the face feature point in the face region. The face feature point may be a pixel corresponding to a facial organ, for example, a pixel corresponding to an organ such as five facial organs and a facial outline. In addition, there are generally a plurality of face feature points. Therefore, the determining the face feature based on the first location information may specifically include: determining a coordinate set of each first location information as the face feature. In addition, the face recognition model may be a model that infers a surface geometric shape of the face of a 3D object such as a target online streamer based on machine learning. Therefore, in this embodiment, it may be ensured that no dedicated depth sensor is required to collect the human body image in this application, to further improve convenience.

Specifically, the face recognition model includes a face region detection sub-model used to recognize the face region and a face feature detection sub-model. The face feature detection sub-model may be used to determine the first location information of the face feature point based on the face region output by the face region detection sub-model. The face region detection sub-model is trained by using a sample human body image and a location label of a face in the sample human body image. The face feature detection sub-model is trained by using a sample face image and a coordinate label of a sample face feature point in the sample face image. In other words, the face recognition model includes a face region detection sub-model for recognizing a face location from a complete human body image, where the sub-model may be considered as a face detector, and includes a face feature detection sub-model for operating a region at the face location. For example, the face feature detection sub-model may be specifically used to predict coordinates of a surface geometric shape of the face by using a regression algorithm, to obtain a feature point coordinate set of the face.

In addition, the online streamer avatar generation method provided in this embodiment of this application may further include the following steps:

if the face feature point fails to be recognized from the face region, returning to the step of obtaining a human body image that is collected by an image collection device and that is of a target online streamer. In other words, when the face feature detection sub-model cannot recognize the face, it indicates that there is very likely no face in a current image, namely, a current video frame. Therefore, a new video frame, namely, a new human body image, may be obtained, to invoke the face region detection sub-model to relocate the face.

In an optional implementation, the recognizing an upper-body limb region from the human body image, and determining the limb feature based on the upper-body limb region may specifically include the following steps:

inputting the human body image into a pre-trained limb recognition model to obtain the upper-body limb region in the human body image;

determining second location information of a limb feature point in the upper-body limb region, and

determining the limb feature based on the second location information.

In specific application, the limb feature refers to data that represents the pose of the upper body of the target online streamer, and the limb feature point refers to a pixel in the limb feature. The pose of the upper body of the target online streamer refers to location and rotation data of the upper body of the target online streamer. The limb recognition model is trained by using a sample human body image, a region label of a sample upper-body limb in the sample human body image, and a location label of a sample limb feature point in the sample upper-body limb. The second location information may be coordinates of the limb feature point in the upper-body limb region. In addition, the location and rotation data of the upper body of the target online streamer may be reflected by the second location information of the limb feature point. For example, if the limb feature point includes an elbow feature point and a hand end (for example, a fingertip of a longest finger) feature point, second location information of the elbow feature point and the hand end feature point may reflect location and rotation data of an arm of the target online streamer. In addition, there are generally a plurality of limb feature points. Therefore, the determining the limb feature based on the second location information may specifically include: determining second location information such as a coordinate set of each limb feature point as the limb feature. In addition, similar to recognition of the face feature point, the limb recognition model includes a limb region detection sub-model used to recognize the limb region and a limb tracking sub-model. The limb tracking sub-model may be used to determine the second location information of the limb feature point based on the limb region output by the limb region detection sub-model. The limb region detection sub-model is trained by using a sample human body image and a location label of a limb in the sample human body image. The limb tracking sub-model is trained by using a sample limb image and a coordinate label of a sample limb feature point in the sample limb image. In other words, first, a region of interest (ROI) of the pose of the upper body is located in an image frame by using the limb region detection sub-model. Then, the limb tracking sub-model uses an ROI clipping frame as an input to recognize a pose feature point in the ROI, namely, the limb feature. The limb region detection sub-model may be considered as a detector, and the limb tracking sub-model may be considered as a tracker.

In one case, if the limb feature point fails to be recognized in the limb region, or a limb feature point in a previous frame does not exist, the system returns to perform the step of recognizing an upper-body limb region from the human body image.

The previous frame is a human body image obtained in previous human body image obtaining of a currently processed human body image. In addition, “a limb feature point in a previous frame does not exist” indicates that the currently processed human body image is very likely the first frame of image in a live video to which the obtained human body image belongs. Therefore, the detector, namely, the limb recognition model, may be invoked to relocate the ROI. For a case other than the case in which the limb feature point fails to be recognized and the case in which the limb feature point in the previous frame does not exist, because the pose is likely to be the same as, similar to, or associated with the previous frame, an ROI to which the limb feature point in the previous frame belongs, namely, pose coordinates of the previous frame, may be directly used to derive the ROI. The pose coordinates are location coordinates of the limb feature point in the human body image.

In an optional implementation, the avatar parameter includes a head pose parameter, a facial expression parameter, and a limb pose parameter.

The setting an avatar parameter of the target online streamer based on the face feature and the limb feature may specifically include the following steps:

performing head pose parsing on the face feature to obtain the head pose parameter;
performing facial expression parsing on the face feature to obtain the facial expression parameter; and

parsing the limb feature to obtain the limb pose parameter.

In specific application, the head pose parameter may represent a head pose of the target online streamer. The facial expression parameter may represent an expression of the target online streamer. The limb pose parameter may represent a pose of the upper body of the target online streamer. Therefore, the head pose parameter may be used to represent a head pose of the avatar of the target online streamer. The facial expression parameter is used to represent an expression of the avatar of the target online streamer. The limb pose parameter is used to represent a pose of the upper body of the avatar of the target online streamer. Therefore, in this embodiment, similarity between the avatar of the target online streamer and the real target online streamer can be improved, to improve accuracy of the avatar.

In an optional implementation, the face feature includes the first location information of the face feature point in the face region in the human body image.

Correspondingly, the performing head pose parsing on the face feature to obtain the head pose parameter may specifically include the following steps:

separately determining location information of a plurality of specified face feature points from the first location information;

determining a roll angle, a yaw angle, and a pitch angle of the head based on the location information of the plurality of specified face feature points and a spatial location relationship between the plurality of specified face feature points on the head of the target online streamer; and determining the head pose parameter based on the roll angle, the yaw angle, and the pitch angle.

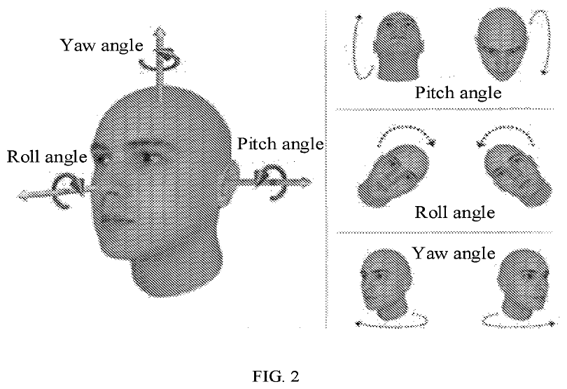

In specific application, as shown in FIG. 2 that is a schematic diagram of a roll angle, a yaw angle, and a pitch angle of a head in an online streamer avatar generation method according to another embodiment of this application, the roll angle is an angle generated when the head rotates around the Y-axis in a three-dimensional coordinate system, the yaw angle is an angle generated when the head rotates around the Z-axis in the three-dimensional coordinate system, and the pitch angle is an angle generated when the head rotates around the X-axis in the three-dimensional coordinate system. In this way, in this embodiment, the head pose parameter is determined based on the roll angle, the yaw angle, and the pitch angle. This can ensure accuracy of the head pose represented by the head pose parameter. In this way, in this embodiment, head pose estimation is implemented, that is, calculation and application of a Euler angle are implemented. The Euler angle is a group of three independent angle parameters, and is used to uniquely determine a location of a rigid body that rotates with respect to a fixed point.

In addition, the determining a roll angle of the head based on the location information of the plurality of specified face feature points and a spatial location relationship between the plurality of specified face feature points on the head of the target online streamer may specifically include: obtaining, from the first location information, location information of a first face feature point and a second face feature point that are located on a face edge and that are in a left-right mirroring relationship, to use the location information as first specified location information; processing the first specified location information as a first face vector, where endpoints of the first face vector are respectively the first face feature point and the second face feature point; and calculating an inverse tangent value of the first face vector to obtain the roll angle. For example, for the roll angle, a roll angle FaceRollRad of a vector VectorAB (x, y, z) connected by a feature point A and a feature point B near two temples, namely, edges of an outline, is obtained. The formula is: VectorAB=AB, and FaceRollRad=arctan (y/x).

In addition, the determining a yaw angle of the head based on the location information of the plurality of specified face feature points and a spatial location relationship between the plurality of specified face feature points on the head of the target online streamer may specifically include: obtaining, from the first location information, location information of a third face feature point representing a mouth center, to use the location as second specified location information; processing the first specified location information and the second specified location information into a second face vector and a third face vector, where endpoints of the second face vector are respectively the first face feature point and a third face feature point, and endpoints of the third face vector are respectively the second face feature point and the third face feature point; and calculating a ratio of a modulus of the second face vector to a modulus of the third face vector, to obtain the yaw angle. For example, for the yaw angle, offsets DiffLeft and DiffRight that are respectively formed between the mouth center C and left and right outlines A and B are determined, and a ratio FaceYawRate between the two offsets is calculated to obtain the yaw angle. The formula is as follows: DiffLeft=|\vec{AC}|, DiffRight=|\vec{BC}|, and FaceYawRate=DiffLeft/DiffRight.

In addition, the determining a pitch angle of the head based on the location information of the plurality of specified face feature points and a spatial location relationship between the plurality of specified face feature points on the head of the target online streamer may specifically include: obtaining, from the first location information, location information of a fourth face feature point representing a left-eye center and the fifth face feature point representing a right-eye center, to use the location information as third specified location information, and obtaining, from the first location information, location information of a sixth face feature point representing a left face edge and the seventh face feature point representing a right face edge, to use the location information as fourth specified location information; calculating a first height average value of the left-eye center and the right-eye center based on the third specified location information; calculating a second height average value of the left face edge and the right face edge based on the fourth specified location information; and calculating a difference between the first height average value and the second height average value and a preset difference, and obtaining a ratio of the difference to the preset difference, to obtain the pitch angle. For example, for the pitch angle, a difference between a height average value EY of the left-eye center and the right-eye center and a height average value FY of a left outline and a right outline is obtained, and a ratio of the difference to a preset difference EFM is calculated as FacePitchRate. FacePitchRate=(EY−FY)/EFM. A sum of vertical coordinates of specified points such as center points at the left, the right, the top, and the bottom of the left eye is obtained, and a height EYL of the left eye is obtained by dividing the sum result by 4. Similarly, a height EYR of the right eye may be obtained, and a difference is that the height is the height of the right eye. An average value of the height EYL of the left eye and the height EYR of the right eye is calculated, so that the height average value EY of the left-eye center and the right-eye center can be obtained. The outline height average value is an average value FY of a vertical coordinate of the sixth face feature point of the left face edge, namely, the left outline of the face, and a vertical coordinate of the seventh face feature point of the right face edge, namely, the right outline of the face. For example, the sixth face feature point may be a feature point, where a difference value between the feature point and the left temple of the face is less than a difference threshold, and the seventh face feature point may be a feature point, where a difference value between the feature point and the right temple of the face is less than a difference threshold. The preset difference EFM may be a maximum difference that is between a first height and a second height and that is collected through test. The first height is an average height of the left eye and the right eye, and the second height is an average height of the left face edge and the right face edge.

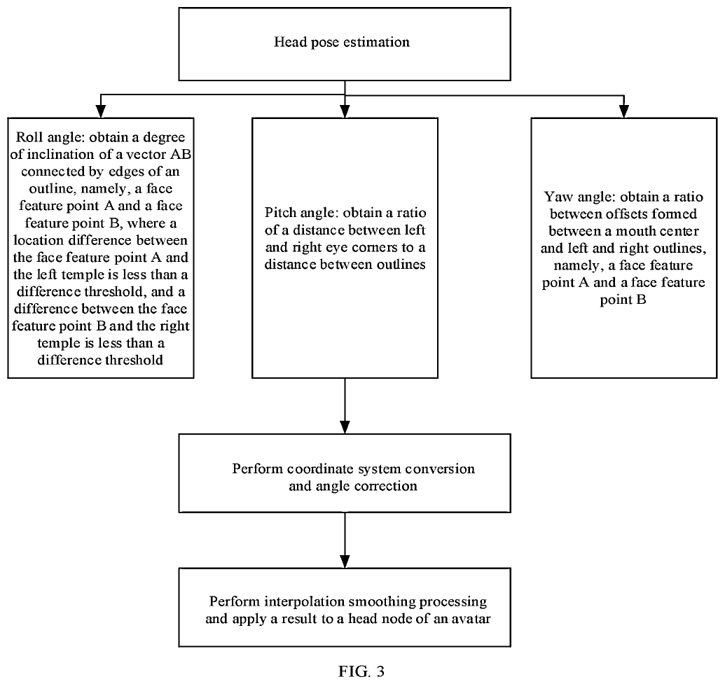

For ease of understanding, FIG. 3 is used as an example for description below. For example, as shown in FIG. 3 that is a schematic flowchart of updating a first type of parameter (i.e., head pose parameter) in an online streamer avatar generation method according to another embodiment of this application, the foregoing head pose estimation may include the following steps:

Roll angle: A roll angle of a vector AB connected by edges of an outline, namely, a face feature point A and a face feature point B, is obtained, where a location difference between the face feature pointA and the left temple is less than a difference threshold, and a difference between the face feature point B and the right temple is less than a difference threshold.

Yaw angle: A ratio between offsets formed between the mouth center and left and right outlines, namely, a face feature point A and a face feature point B, is obtained. The mouth center is MouthCenter.

Pitch angle: A ratio of a distance between left and right eye corners to a distance between the outlines is obtained.

Coordinate system conversion and angle correction are performed. Interpolation smoothing processing is performed, and a result is applied to a head node of an avatar.

In a form of an optional embodiment, the following specifically describes coordinate system conversion, angle correction, and interpolation smoothing processing.

In an optional implementation, the determining the head pose parameter based on the roll angle, the yaw angle, and the pitch angle may specifically include the following steps:

separately converting the roll angle, the yaw angle, and the pitch angle into coordinates in a two-dimensional coordinate system to obtain a coordinate conversion result; and

performing angle value correction and interpolation smoothing processing on the coordinate conversion result to obtain the head pose parameter.

In specific application, the roll angle, the yaw angle, and the pitch angle are angles in the three-dimensional coordinate system. In addition, in one case, the avatar is a two-dimensional image. Therefore, the roll angle, the yaw angle, and the pitch angle may be converted from the three-dimensional coordinate system to the two-dimensional coordinate system based on a spatial mapping relationship. In another case, the avatar is a three-dimensional image. Therefore, no coordinate system conversion needs to be performed, and the head pose parameter may be obtained by directly correcting and performing interpolation smoothing processing on the roll angle, the yaw angle, and the pitch angle. In addition, angle value correction may specifically include: comparing a difference between the roll angle and a roll angle threshold, comparing a difference between the yaw angle and a yaw angle threshold, and comparing a difference between the pitch angle and a pitch angle threshold; and if a difference corresponding to any angle is greater than an angle difference threshold, adjusting the angle, so that a difference corresponding to the adjusted angle is less than or equal to the angle difference threshold. Interpolation smoothing processing means finding a rule in a known data sequence based on the known data sequence (or may be understood as a series of discrete points in coordinates), and then estimating, based on the found rule, a value of a point having no data record, to properly compensate for a missing part in the data. In addition, a change of the head pose parameter may reflect a head rotation process of the avatar. Therefore, in specific application, to reduce a problem that the avatar does not conform to human motion logic due to an abnormal head rotation rate, a change rate of the head pose parameter may be corrected. Specifically, a difference between a current head pose parameter and a previous head pose parameter may be determined, and a ratio of the difference value to preset duration is calculated, to obtain a change rate. When the change rate is greater than a rotation rate threshold, the change rate is adjusted to be less than or equal to the rotation rate threshold. For example, at least one intermediate head pose parameter between the current head pose parameter and the previous head pose parameter may be determined, and the intermediate head pose parameter is determined as the current head pose parameter. In this way, with the intermediate head pose parameter, the head pose parameter may change at a change rate conforming to the human motion logic, that is, the head rotation rate of the avatar is normal.

In this embodiment, 3D data may be applied to a two-dimensional avatar through coordinate conversion and angle correction, and accuracy of the avatar parameter is further improved through interpolation smoothing processing.

In an optional implementation, the face feature includes the first location information of the face feature point in the face region in the human body image.

Correspondingly, the performing facial expression parsing on the face feature to obtain the facial expression parameter may specifically include the following steps:

determining location information of expression feature points, where the expression feature points are face feature points whose location information changes with an expression on the face of the target online streamer; obtaining specified expression parameters that represents a basic/reference face feature points; and determining change coefficients of the expression feature points as the second type of parameter (i.e., facial expression parameter) based on the location information of the expression feature points in the face region and the specified expression parameters.

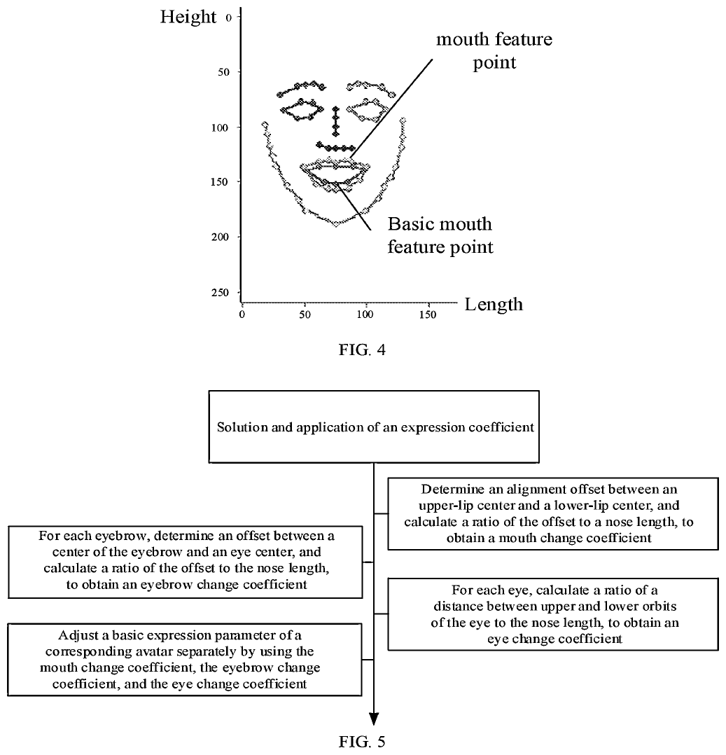

In specific application, as shown in FIG. 4 that is a schematic diagram of expression feature points in an online streamer avatar generation method according to another embodiment of this application. The expression feature points (e.g., mouth feature points) are face feature points that change with an expression on the face of the target online streamer. The specified/predetermined expression parameters indicate basic/reference face feature points (e.g., basic/reference mouth feature points). The determining change coefficients of the expression feature points as the facial expression parameters based on the location information of expression feature points and the specified expression parameters may specifically include: in the two-dimensional coordinate system, performing alignment on the basic face feature points and the expression feature points by using the location information of the expression feature points and the specified expression parameters, to obtain an alignment result; and determining the change coefficients of the expression feature points as the facial expression parameters based on location information in the alignment result.

In addition, the determining the change coefficients of the expression feature points as the facial expression parameters based on location information in the alignment result may include: performing center alignment for a key pose and a mouth key point in a current frame, and then solving a mouth expression coefficient; separately obtaining a ratio of an offset between one eyebrow center and an eye center to a nose length, to calculate an eyebrow coefficient; obtaining a ratio of a distance between upper and lower orbits to the nose length, to calculate a blink coefficient; and calculating another expression coefficient and combining the coefficients. For example, as shown in FIG. 5 that is a schematic flowchart of updating facial expression parameters in an online streamer avatar generation method according to another embodiment of this application, solution and application of the expression coefficient may include the following steps:

determining an alignment offset between an upper-lip center and a lower-lip center, and calculating a ratio of the offset to the nose length, to obtain a mouth change coefficient;

for each eyebrow, determining an offset between a center of the eyebrow and an eye center, and calculating a ratio of the offset to the nose length, to obtain an eyebrow change coefficient;

for each eye, calculating a ratio of a distance between upper and lower orbits of the eye to the nose length, to obtain an eye change coefficient; and

adjusting a basic expression parameter of a corresponding avatar separately by using the mouth change coefficient, the eyebrow change coefficient, and the eye change coefficient.

In the foregoing embodiments in FIG. 3 and FIG. 5, in this application, pose data and expression data of the head may be calculated based on a coordinate set of a face feature point, to generate the head and the face of the avatar by using the obtained data.

In an optional implementation, the limb feature includes the second location information of the limb feature point in the upper-body limb region.

Correspondingly, the parsing the limb feature to obtain the limb pose parameter may specifically include the following steps:

determining location information of a limb node based on the location information of the limb feature points in the upper-body limb region recognized from the human body image of the target online streamer by a pre-trained limb recognition model; and

determining a change parameter of the limb node based on the location information of the limb node and a preset rule about a limb movement rule to obtain the third type of parameter (i.e., limb pose parameter).

In specific application, the determining change data of the limb node based on the location information of the limb node and the preset limb movement rule may include the following steps: processing, into a limb feature vector, location information of target limb nodes belonging to a same limb, where endpoints of the limb feature vector are the target limb nodes; and converting the limb feature vector into a unit direction vector to obtain the change data of the limb node. Specifically, each current limb length and location information of each current limb node in current limb pose data may be obtained. A limb node pair that is among the current limb nodes and that has a movement association relationship is determined, where any limb node pair includes one fixed limb node and one moving limb node. For each limb node pair, based on location information of a fixed limb node in the limb node pair, target location information of a moving limb node in the limb node pair is calculated by using change data of a limb node corresponding to the limb node pair and a limb length formed by the limb node pair. Current location information of the corresponding moving limb node in the current limb pose data is updated by using the target location information. For example, skeleton node data of the avatar is obtained, and a skeleton length between all skeleton nodes is calculated. A skeleton node D and a skeleton node E are used as an example: A skeleton length DE: DE=|\vec{DE}| is calculated. A unit direction vector NFG=\vec{FG}/|\vec{FG}| of corresponding feature points F and G is calculated. In this case, with D as a reference, a target location of the skeleton node E is E=D+NFG*DE.

In one case, the online streamer avatar generation method provided in this embodiment of this application may further include the following step: correcting a location and an angle of each limb node.

In specific application, whether a location difference between adjacent limb nodes is greater than a difference threshold may be determined through comparison. If the location difference between the adjacent limb nodes is greater than the difference threshold, locations of the adjacent limb nodes are adjusted, so that the difference is less than or equal to the joint difference threshold. In addition, if an angle formed by the limb node is greater than an angle threshold, the angle formed by the limb node is adjusted to be less than or equal to the angle threshold. In this way, a problem such as joint distortion and mutual penetration can be reduced by limiting the joint difference threshold and the angle threshold. In addition, similar to a reference head pose parameter, a change of a reference limb pose parameter may reflect a movement rate of the limb. Therefore, a change rate of the reference limb pose parameter may be determined. If the change rate is greater than the limb rate threshold, the change rate of the reference limb pose parameter is adjusted to be less than or equal to the limb rate threshold.

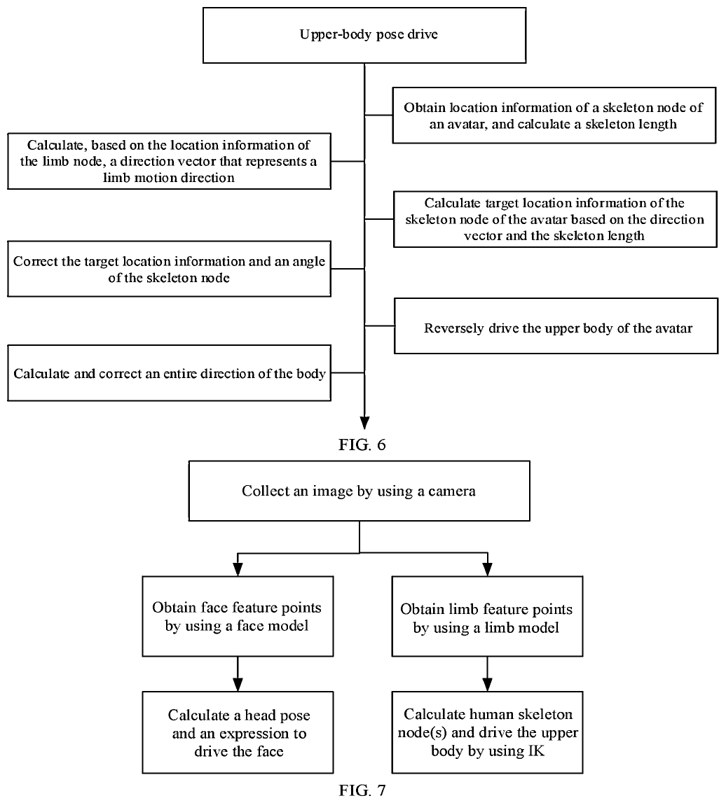

For example, as shown in FIG. 6 that is a schematic flowchart of updating a limb pose parameter in an online streamer avatar generation method according to another embodiment of this application, the upper-body pose drive may specifically include the following steps:

obtaining location information of a skeleton node of an avatar, and calculating a skeleton length; calculating, based on the location information of the limb node, a direction vector that represents a limb motion direction; calculating target location information of the skeleton node of the avatar based on the direction vector and the skeleton length; correcting the target location information and an angle of the skeleton node; reversely driving the upper body of the avatar; and calculating and correcting an entire direction of the upper body of the avatar.

In this embodiment, the limb node of the avatar is specifically a skeleton node. The skeleton node of the avatar is E, and a target location of the skeleton node E is equal to D+NFG*DE. The skeleton node E is adjusted to the target location, and a location of an associated skeleton point is adjusted based on a movement relationship between the skeleton node E and the associated skeleton point. The associated skeleton point is a skeleton point that has a joint-driven relationship with the skeleton node E. For example, an associated skeleton point at the end of the hand includes the elbow and the shoulder.

In an optional implementation, the generating an avatar corresponding to the target online streamer based on the avatar parameter may specifically include the following steps:

determining whether an avatar corresponding to the avatar parameter meets a preset abnormality condition; and

if the avatar corresponding to the avatar parameter meets the preset abnormality condition, correcting the avatar to obtain the avatar corresponding to the target online streamer.

In this embodiment, when the avatar corresponding to the avatar parameter meets the preset abnormality condition, the avatar is corrected, so that accuracy of the avatar corresponding to the target online streamer can be further improved. In addition, if the avatar corresponding to the avatar parameter does not meet the preset abnormality condition, the avatar corresponding to the avatar parameter is directly used as the avatar corresponding to the target online streamer. This may improve efficiency compared with a manner of correcting the avatar each time.

In specific application, that the avatar corresponding to the avatar parameter meets the preset abnormality condition may include: obtaining head location information and location information of the two shoulders corresponding to the avatar parameter; determining a head deflection direction of the avatar based on the head location information; determining an upper-body deflection direction of the avatar based on the location information of the two shoulders; and if a difference between the head deflection direction and the upper-body deflection direction is greater than a deflection direction threshold, adjusting the upper-body deflection direction, so that the difference is less than or equal to the deflection direction threshold. In addition, to ensure that a rotation rate of the upper body conforms to human motion logic, a change rate of the location information of the two shoulders may be obtained. When the change rate is greater than a preset rotation rate threshold, the change rate is adjusted to be less than or equal to the preset rotation rate threshold.

For ease of understanding, the following provides integrated descriptions for the foregoing partial embodiments of this application with reference to FIG. 7. For example, as shown in FIG. 7 that is a schematic flowchart of an online streamer avatar generation method according to another embodiment of this application, the method may include the following steps:

collecting an image by using a camera; obtaining face feature points by using a face model that is pre-trained to recognize faces; obtaining limb feature points by using a limb model that is pre-trained to recognize lime regions; calculating a head pose and an expression based on the face feature points to drive the face of the virtual character (i.e., avatar) corresponding to the target streamer; and calculating skeleton node (s) based on the limb feature points and driving the upper body of the avatar using Inverse Kinematics (IK).

Specifically, first, an image collected by the camera is obtained. A pre-trained face model is used to recognize a face in the image collected by the camera, and a set of coordinates of face feature points is obtained using the pre-trained face model. A pre-trained limb model is used to recognize the upper-body limb of the human body in the image captured by the camera, and a set of coordinates of limb feature points is obtained using the pre-trained limb model. Head pose data and expression data are calculated based on the coordinate set of the face feature points, and they are used to drive the head motion and the facial expression of the avatar (i.e., virtual character) corresponding to the target online streamer. Relative displacement data of a skeleton node of the human body is calculated based on the coordinate set of the limb feature points, and the upper-body limb of the avatar is driven by using IK. Driving the upper-body limb of the avatar can ensure that the avatar has an upper-body limb motion the same as or similar to that of the target online streamer. Steps in this embodiment are similar to steps that are in the foregoing embodiment in FIG. 1 and the optional embodiment in FIG. 1 and that have a same function, and a difference lies in that different descriptions are used in this embodiment for brevity description. The face model in this embodiment is the face recognition model in the foregoing optional embodiment in FIG. 1, and the limb model is the limb recognition model in the foregoing optional embodiment in FIG. 1. For a same part, refer to the foregoing descriptions of the embodiment in FIG. 1 and the optional embodiment in FIG. 1. Details are not described herein again.

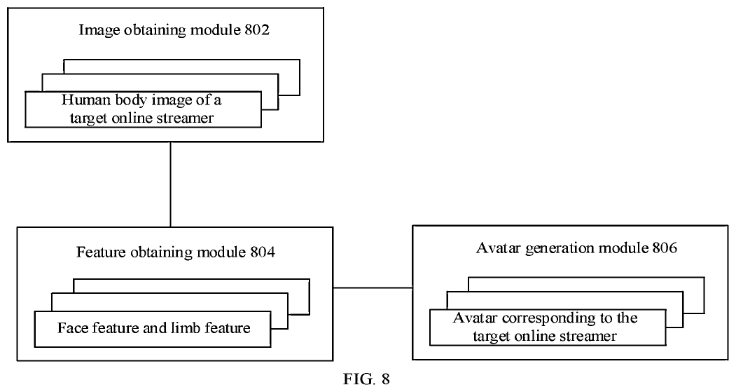

Corresponding to the foregoing method embodiments, this application further provides an embodiment of an online streamer avatar generation apparatus. FIG. 8 is a schematic diagram of a structure of an online streamer avatar generation apparatus according to an embodiment of this application. As shown in FIG. 8, the apparatus includes:

an image obtaining module 802, configured to obtain a human body image that is collected by an image collection device and that is of a target online streamer, where the human body image includes at least the face and the upper body of the target online streamer;

a feature obtaining module 804, configured to separately perform face recognition and upper-body limb recognition on the human body image to obtain a face feature and a limb feature; and

an avatar generation module 806, configured to: set an avatar parameter of the target online streamer based on the face feature and the limb feature, and generate an avatar corresponding to the target online streamer based on the avatar parameter.

In an embodiment of this application, a limb motion of the upper body is generally characterized by a small change amplitude and a small change speed. In addition, the human body image includes at least the face of and the upper body of the target online streamer. Therefore, the human body image collected by the image collection device is directly obtained, so that face recognition and upper-body limb recognition can be separately performed on the human body image to obtain the face feature and the limb feature. In addition, the face feature and the limb feature represent features of the head and the upper body of the target online streamer, and may reflect a motion and an expression of the target online streamer. Therefore, in this embodiment, the motion and the expression of the target online streamer may be directly captured by using the image collection device, and a dedicated capture device does not need to be used. On this basis, the avatar parameter of the target online streamer is set based on the face feature and the limb feature, and the avatar corresponding to the target online streamer is generated based on the avatar parameter. This can ensure that the generated avatar corresponds to the motion and the expression of the target online streamer, to ensure content richness in livestreaming. Therefore, in this solution, an online streamer avatar can be generated without using the dedicated capture device, so that both convenience and content richness in livestreaming can be considered.

In an optional implementation, the feature obtaining module 804 is further configured to:

recognize a face region from the human body image, and determining the face feature based on the face region; and

recognize an upper-body limb region from the human body image, and determining the limb feature based on the upper-body limb region.

In an optional implementation, the feature obtaining module 804 is further configured to: input the human body image into a pre-trained face recognition model to obtain the face region in the human body image; and

determine first location information of a face feature point in the face region, and determine the face feature based on the first location information.

In an optional implementation, the feature obtaining module 804 is further configured to: input the human body image into a pre-trained limb recognition model to obtain the upper-body limb region in the human body image;

determine second location information of a limb feature point in the upper-body limb region, and determine the limb feature based on the second location information.

In an optional implementation, the avatar parameter includes a head pose parameter, a facial expression parameter, and a limb pose parameter.

Correspondingly, the feature obtaining module 804 is further configured to:

perform head pose parsing on the face feature to obtain the head pose parameter;

perform facial expression parsing on the face feature to obtain the facial expression parameter; and parse the limb feature to obtain the limb pose parameter.

In an optional implementation, the face feature includes the first location information of the face feature point in the face region in the human body image.

Correspondingly, the feature obtaining module 804 is further configured to:

separately determine location information of a plurality of specified face feature points from the first location information;

determine a roll angle, a yaw angle, and a pitch angle of the head based on the location information of the plurality of specified face feature points and a spatial location relationship between the plurality of specified face feature points on the head of the target online streamer; and

determine the head pose parameter based on the roll angle, the yaw angle, and the pitch angle.

In an optional implementation, the feature obtaining module 804 is further configured to:

separately convert the roll angle, the yaw angle, and the pitch angle into coordinates in a two-dimensional coordinate system to obtain a coordinate conversion result; and

perform angle value correction and interpolation smoothing processing on the coordinate conversion result to obtain the head pose parameter.

In an optional implementation, the face feature includes the first location information of the face feature point in the face region in the human body image.

Correspondingly, the feature obtaining module 804 is further configured to:

determine reference location information of an expression feature point from the first location information, where the expression feature point is a face feature point that changes with an expression and that is on the face of the target online streamer;

obtain a specified expression parameter that represents a basic face feature point; and

determine a change coefficient of the expression feature point as the facial expression parameter based on the reference location information and the specified expression parameter.

In an optional implementation, the limb feature includes the second location information of the limb feature point in the upper-body limb region.

Correspondingly, the feature obtaining module 804 is further configured to:

determine location information of a limb node based on the second location information; and

determine a change parameter of the limb node based on the location information of the limb node and a preset limb movement rule, to obtain the limb pose parameter.

In an optional implementation, the avatar generation module 806 is further configured to:

determine whether an avatar corresponding to the avatar parameter meets a preset abnormality condition; and

if the avatar corresponding to the avatar parameter meets the preset abnormality condition, correct the avatar to obtain the avatar corresponding to the target online streamer.

The foregoing is the schematic solution of the online streamer avatar generation apparatus in this embodiment. It should be noted that the technical solution of the online streamer avatar generation apparatus and the technical solution of the online streamer avatar generation method belong to a same concept. For details not described in detail in the technical solution of the online streamer avatar generation apparatus, refer to the descriptions of the technical solution of the online streamer avatar generation method.

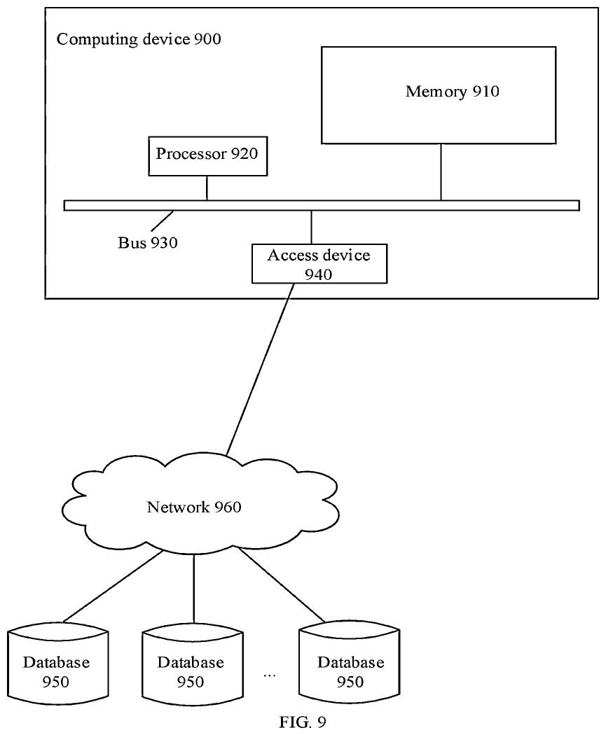

FIG. 9 is a block diagram of a structure of a computing device according to an embodiment of this application. Components of the computing device 900 include but are not limited to a memory 910 and a processor 920. The processor 920 and the memory 910 are connected by using a bus 930, and a database 950 is configured to store data.

The computing device 900 further includes an access device 940, and the access device 940 enables the computing device 900 to perform communication by using one or more networks 960.

Examples of these networks include a public switched telephone network (PSTN), a local area network (LAN), a wide area network (WAN), a personal area network (PAN), or a combination of communication networks such as the Internet. The access device 940 may include one or more of any types of wired or wireless network interfaces (for example, a network interface controller (NIC)), for example, an IEEE 802.11 wireless local area network (WLAN) wireless interface, a worldwide interoperability for microwave access (Wi-MAX) interface, an Ethernet interface, a universal serial bus (USB) interface, a cellular network interface, a Bluetooth interface, and a near field communication (NFC) interface.

In an embodiment of this application, the foregoing components of the computing device 900 and other components not shown in FIG. 9 may be alternatively connected to each other, for example, by using the bus. It should be understood that the block diagram of the structure of the computing device shown in FIG. 9 is merely used as an example instead of a limitation on the scope of this application. A person skilled in the art may add or replace other components as required.

The computing device 900 may be any type of still or mobile computing device, including: a mobile computer or a mobile computing device (for example, a tablet computer, a personal digital assistant, a laptop computer, a notebook computer, or a netbook), a mobile phone (for example, a smartphone), a wearable computing device (for example, a smartwatch or smart glasses); another type of mobile device; or a still computing device, for example, a desktop computer or a PC. The computing device 900 may alternatively be a mobile or still server.

When executing the computer instructions, the processor 920 implements steps of the online streamer avatar generation method.

The foregoing describes the schematic solution of the computing device in this embodiment. It should be noted that the technical solution of the computing device and the technical solution of the online streamer avatar generation method belong to a same concept. For details not described in detail in the technical solution of the computing device, refer to the descriptions of the technical solution of the online streamer avatar generation method.

An embodiment of this application further provides a computer-readable storage medium, where the computer-readable storage medium stores computer instructions, and when the computer instructions are executed by a processor, steps of the online streamer avatar generation method are implemented.

The foregoing describes the schematic solution of the computer-readable storage medium in this embodiment. It should be noted that the technical solution of the storage medium and the technical solution of the online streamer avatar generation method belong to a same concept. For details not described in detail in the technical solution of the storage medium, refer to the descriptions of the technical solution of the online streamer avatar generation method.

Specific embodiments of this application are described above. Other embodiments fall within the scope of the appended claims. In some cases, the actions or steps recorded in the claims can be performed in an order different from the order in the embodiments and the desired results can still be achieved. In addition, the process depicted in the accompanying drawings does not necessarily require the shown particular order or consecutive order to achieve the desired results. In some implementations, multi-task processing and parallel processing can or may be advantageous.

The computer instructions include computer program code. The computer program code may be in a source code form, an object code form, an executable file form, an intermediate form, or the like. The computer-readable medium may include any entity or apparatus, a recording medium, a USB flash drive, a removable hard disk, a magnetic disk, an optical disc, a computer memory, a read-only memory (ROM), a random access memory (RAM), an electrical carrier signal, a telecommunications signal, a software distribution medium, and the like that can carry the computer program code.

It should be noted that, for ease of description, the foregoing method embodiments are described as a combination of a series of actions. However, a person skilled in the art should understand that this application is not limited to the described action sequence, because according to this application, some steps may be performed in another order or simultaneously. In addition, a person skilled in the art should also understand that the described embodiments in this specification are all preferred embodiments, and the used actions and modules are not necessarily mandatory to this application.

In the foregoing embodiments, descriptions of the embodiments have respective focuses. For a part that is not described in detail in an embodiment, refer to related descriptions in another embodiment.

The preferred embodiments of this application disclosed above are merely intended to help describe this application. In the optional embodiments, all details are not described in detail, and the present invention is not limited to the specific implementations. Clearly, many modifications and changes may be made based on the content of this application. These embodiments are selected and specifically described in this application to better explain the principle and the actual application of this application, so that a person skilled in the art can better understand and use this application. This application is only subjected to the claims and the scope and equivalents thereof.

What is claimed is:

1. A method of generating a virtual character for an online streamer, comprising:
obtaining a human body image of a target online streamer captured by an image collection device, wherein the human body image of the target online streamer comprises a face and an upper body part of the target online streamer;
separately performing face recognition and upper-body limb recognition on the human body image to obtain face features and limb features;
determining parameters associated with a virtual character corresponding to the target online streamer based on the face features and the limb features; and
generating the virtual character corresponding to the target online streamer based on the parameters, wherein the generated virtual character has a motion and an expression corresponding to that of the target online streamer.

2. The method according to claim 1, wherein the separately performing face recognition and upper-body limb recognition on the human body image to obtain face features and limb features comprises:
recognizing a face region from the human body image, and determining the face features based on the face region; and
recognizing an upper-body limb region from the human body image, and determining the limb features based on the upper-body limb region.

3. The method according to claim 2, wherein the recognizing a face region from the human body image, and determining the face features based on the face region comprises:
inputting the human body image into a pre-trained face recognition model to obtain the face region; and
determining location information of face feature points in the face region, and determining the face features based on the location information of the face feature points in the face region.

4. The method according to claim 2, wherein the recognizing an upper-body limb region from the human body image, and determining the limb features based on the upper-body limb region comprises:
inputting the human body image into a pre-trained limb recognition model to obtain the upper-body limb region; and
determining location information of limb feature points in the upper-body limb region, and determining the limb features based on the location information of the limb feature points in the upper-body limb region.

5. The method according to claim 1, wherein the parameters comprises a first type of parameter indicating a head pose of the target online streamer, a second type of parameter indicating a facial expression of the target online streamer, and a third type of parameter indicating a limb pose of the target online streamer; and wherein the generating parameters associated with a virtual character corresponding to the target online streamer based on the face features and the limb features further comprises:
generating the first type of parameter by performing head pose parsing on the face features,
generating the second type of parameter by performing facial expression parsing on the face features, and
generating the third type of parameter based on parsing the limb features.

6. The method according to claim 5, wherein the face features comprise location information of face feature points in a face region recognized from the human body image by a pre-trained face recognition model; and wherein the generating the first type of parameter by performing head pose parsing on the face features comprises:
separately determining location information of a plurality of specified face feature points in the face region,
determining a roll angle, a yaw angle, and a pitch angle of a head of the target online streamer based on the location information of the plurality of specified face feature points and a spatial location relationship between the plurality of specified face feature points on the head of the target online streamer, and
determining the first type of parameter based on the roll angle, the yaw angle, and the pitch angle.

7. The method according to claim 6, wherein the determining the first type of parameter based on the roll angle, the yaw angle, and the pitch angle comprises:
separately converting the roll angle, the yaw angle, and the pitch angle into coordinates in a two-dimensional coordinate system to obtain a coordinate conversion result; and
performing angle value correction and interpolation smoothing processing on the coordinate conversion result to obtain the first type of parameter.

8. The method according to claim 5, wherein the face features comprise location information of face feature points in a face region recognized from the human body image by a pre-trained face recognition model; and wherein the generating the second type of parameter by performing facial expression parsing on the face features comprises:
determining location information of expression feature points in the face region, wherein the expression feature points are face feature points whose location information changes with an expression on the face of the target online streamer,
obtaining predetermined expression parameters indicative of reference face feature points corresponding to the expression feature points, and
determining change coefficients of the expression feature points as the second type of parameter based on the location information of the expression feature points in the face region and the predetermined expression parameters.

9. The method according to claim 5, wherein the limb features comprise the location information of limb feature points in an upper-body limb region recognized from the human body image by a pre-trained limb recognition model; and wherein the generating the third type of parameter based on parsing the limb features comprises:
determining location information of limb nodes based on the location information of the limb feature points in the upper-body limb region, and
determining change parameters of the limb nodes based on the location information of the limb nodes and a predetermined rule about a limb movement to obtain the third type of parameter.

10. The method according to claim 1, further comprising:
driving a head motion of the virtual character using a first type of parameter indicating head poses of the target online streamer;
driving a facial expression of the virtual character using a second type of parameter indicating a facial expression of the target online streamer; and
driving an upper-body limb motion of the virtual character based on a third type of parameter indicating limb poses of the target online streamer.

11. A system of generating a virtual character for an online streamer, comprising:
at least one processor; and
at least one memory communicatively coupled to the at least one processor and comprising computer-readable instructions that upon execution by the at least one processor cause the at least one processor to perform operations comprising:
obtaining a human body image of a target online streamer captured by an image collection device, wherein the human body image of the target online streamer comprises a face and an upper body part of the target online streamer;
separately performing face recognition and upper-body limb recognition on the human body image to obtain face features and limb features;
determining parameters associated with a virtual character corresponding to the target online streamer based on the face features and the limb features; and
generating the virtual character corresponding to the target online streamer based on the parameters, wherein the generated virtual character has a motion and an expression corresponding to that of the target online streamer.

12. The system according to claim 11, wherein the parameters comprises a first type of parameter indicating a head pose of the target online streamer, a second type of parameter indicating a facial expression of the target online streamer, and a third type of parameter indicating a limb pose of the target online streamer; and wherein the generating parameters associated with a virtual character corresponding to the target online streamer based on the face features and the limb features further comprises:
generating the first type of parameter by performing head pose parsing on the face features,
generating the second type of parameter by performing facial expression parsing on the face features, and
generating the third type of parameter based on parsing the limb features.

13. The system according to claim 12, wherein the face features comprise location information of face feature points in a face region recognized from the human body image by a pre-trained face recognition model; and wherein the generating the first type of parameter by performing head pose parsing on the face features comprises:
separately determining location information of a plurality of specified face feature points in the face region,
determining a roll angle, a yaw angle, and a pitch angle of a head of the target online streamer based on the location information of the plurality of specified face feature points and a spatial location relationship between the plurality of specified face feature points on the head of the target online streamer, and
determining the first type of parameter based on the roll angle, the yaw angle, and the pitch angle.

14. The system according to claim 12, wherein the face features comprise location information of face feature points in a face region recognized from the human body image by a pre-trained face recognition model; and wherein the generating the second type of parameter by performing facial expression parsing on the face features comprises:
determining location information of expression feature points in the face region, wherein the expression feature points are face feature points whose location information changes with an expression on the face of the target online streamer,
obtaining predetermined expression parameters indicative of reference face feature points corresponding to the expression feature points, and
determining change coefficients of the expression feature points as the second type of parameter based on the location information of the expression feature points in the face region and the predetermined expression parameters.

15. The system according to claim 12, wherein the limb features comprise the location information of limb feature points in an upper-body limb region recognized from the human body image by a pre-trained limb recognition model; and wherein the generating the third type of parameter based on parsing the limb features comprises:
determining location information of limb nodes based on the location information of the limb feature points in the upper-body limb region, and
determining change parameters of the limb nodes based on the location information of the limb nodes and a predetermined rule about a limb movement to obtain the third type of parameter.

16. A non-transitory computer-readable storage medium, storing computer-readable instructions that upon execution by a processor cause the processor to implement operations comprising:
obtaining a human body image of a target online streamer captured by an image collection device, wherein the human body image of the target online streamer comprises a face and an upper body part of the target online streamer;
separately performing face recognition and upper-body limb recognition on the human body image to obtain face features and limb features;
determining parameters associated with a virtual character corresponding to the target online streamer based on the face features and the limb features; and
generating the virtual character corresponding to the target online streamer based on the parameters, wherein the generated virtual character has a motion and an expression corresponding to that of the target online streamer.

17. The non-transitory computer-readable storage medium according to claim 16, wherein the parameters comprises a first type of parameter indicating a head pose of the target online streamer, a second type of parameter indicating a facial expression of the target online streamer, and a third type of parameter indicating a limb pose of the target online streamer; and wherein the generating parameters associated with a virtual character corresponding to the target online streamer based on the face features and the limb features further comprises:
generating the first type of parameter by performing head pose parsing on the face features,
generating the second type of parameter by performing facial expression parsing on the face features, and
generating the third type of parameter based on parsing the limb features.

18. The non-transitory computer-readable storage medium according to claim 17, wherein the face features comprise location information of face feature points in a face region recognized from the human body image by a pre-trained face recognition model; and wherein the generating the first type of parameter by performing head pose parsing on the face features comprises:
separately determining location information of a plurality of specified face feature points in the face region,
determining a roll angle, a yaw angle, and a pitch angle of a head of the target online streamer based on the location information of the plurality of specified face feature points and a spatial location relationship between the plurality of specified face feature points on the head of the target online streamer, and
determining the first type of parameter based on the roll angle, the yaw angle, and the pitch angle.

19. The non-transitory computer-readable storage medium according to claim 17, wherein the face features comprise location information of face feature points in a face region recognized from the human body image by a pre-trained face recognition model; and wherein the generating the second type of parameter by performing facial expression parsing on the face features comprises:
determining location information of expression feature points in the face region, wherein the expression feature points are face feature points whose location information changes with an expression on the face of the target online streamer,
obtaining predetermined expression parameters indicative of reference face feature points corresponding to the expression feature points, and
determining change coefficients of the expression feature points as the second type of parameter based on the location information of the expression feature points in the face region and the predetermined expression parameters.

20. The non-transitory computer-readable storage medium according to claim 17, wherein the limb features comprise the location information of limb feature points in an upper-body limb region recognized from the human body image by a pre-trained limb recognition model; and wherein the generating the third type of parameter based on parsing the limb features comprises:
determining location information of limb nodes based on the location information of the limb feature points in the upper-body limb region, and
determining change parameters of the limb nodes based on the location information of the limb nodes and a predetermined rule about a limb movement to obtain the third type of parameter.
